(19) United States
(12) Patent Application Publication
(10) Pub. No.: US 2026/0099294 A1
(43) Pub. Date: Apr. 9, 2026

(54) AUDIO PLAYBACK DEVICES WITH BATTERY AS SUPPLEMENTAL POWER SOURCE

(71) Applicant: Sonos, Inc., Santa Barbara, CA (US)

(72) Inventor: Joern Riemer, Boston, MA (US)

(21) Appl. No.: 19/115,572

(22) PCT Filed: Sep. 29, 2023
(86) PCT No.: PCT/US2023/075516

§ 371 Date: Mar. 26, 2025

Related U.S. Application Data
(60) Provisional application No. 63/377,766, filed on Sep. 30, 2022.
(60) Provisional application No. 63/377,768, filed on Sep. 30, 2022.

(51) Int. Cl. G06F 3/16; H02J 7/00; H04R 3/12; H04R 27/00

(52) U.S. Cl. CPC G06F 3/162; G06F 3/165; H02J 7/855; H04R 3/12; H04R 27/00; H04R 2227/005; H04R 2420/09

(57) ABSTRACT

Examples include audio playback devices having power circuitry that is configured to receive supplemental power from a battery to provide sufficient power to meet peak power demands of the device, and methods of operating such audio playback devices.

### CROSS-REFERENCE TO RELATED APPLICATIONS

This application claims priority to U.S. Provisional Application No. 63/377,766, titled “Audio Playback Devices with Battery as Supplemental Power Source,” filed on Sep. 30, 2022, and U.S. Provisional Application No. 63/377,768, titled “Coordination of Standby Functions in Audio Playback Devices with Battery as Supplemental Power Source,” filed on Sep. 30, 2022. The disclosures of U.S. Provisional Application Nos. 63/377,766 and 63/377,768 are incorporated herein by reference in their entireties.

### FIELD OF THE DISCLOSURE

The present disclosure is related to consumer goods and, more particularly, to methods, systems, products, features, services, and other elements directed to media play back or some aspect thereof.

### BACKGROUND

Audio playback systems have evolved from modular devices, which can include separate source, amplifier, and speaker components, to stand-alone platforms that integrate high fidelity sound reproduction with audio players and/or streaming services that digitally deliver the source material to one or more small volume integral speakers having a broad frequency response. Such audio platforms are particularly well suited for multi-device applications, where separate playback devices having speakers can be coordinated, for example, to play a single audio stream on several speakers synchronously in the same listening zone (e.g., in the same room) or to play multiple audio streams on speakers in different listening zones (e.g., in separate rooms). Regardless of the arrangement, each playback device requires a source of power for operation.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media play back system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 2 is a block diagram of a playback device, in accordance with an example of the present disclosure.

FIG. 3 is a block diagram of the playback device of FIG. 2 in further detail, in accordance with an example of the present disclosure.

FIG. 4 is a block diagram showing the play back device of FIG. 3 in the first state of operation, in accordance with an example of the present disclosure.

FIG. 5 is a block diagram of an audio playback system having two or more play back devices in accordance with an example of the present disclosure.

FIG. 6 is a block diagram showing the playback device of FIG. 3 in the second state of operation, in accordance with an example of the present disclosure.

FIG. 7 is a block diagram of the playback device of FIG. 2, in accordance with another example of the present disclosure.

FIG. 8 is a flow diagram of a process of controlling a playback device, in accordance with an example of the present disclosure.

FIG. 9 is a flow diagram of a process of controlling a playback device, in accordance with another example of the present disclosure.

FIG. 10 is a block diagram showing various states of operation of the play back devices of FIG. 5, in accordance with an example of the present disclosure.

FIG. 11 is a flow diagram of an example method of coordinating standby functions in audio playback devices, in accordance with an example of the present disclosure.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

This disclosure relates to techniques for improved energy efficiency of audio playback devices. The disclosed techniques are particularly useful for externally powered audio playback devices that include a battery as a supplemental or alternative source of power. Typical audio playback devices, such as those having one or more speakers that produce sound from a digital audio data stream, are generally configured to be powered directly from an alternating current (AC) power source external to the device. For example, the audio playback device can be designed to receive power primarily from an electric utility that distributes electricity produced at a remote location or from a local power source, such as a generator, solar array, or other high capacity energy infrastructure. Although some play back devices are designed to operate solely or primarily from a battery, such batteries are depleted within a few hours of operation, thus severely constraining the usability of the device. While larger batteries can provide longer operating times, inevitably the batteries are depleted within one day's worth of operation, and therefore are not suitable for permanent or semi-permanent installations with high use rates. Therefore, to the extent that batteries are available as a source of power (either internal or external), the batteries are typically not the sole source of power for such playback devices, but rather supplemental, secondary, or otherwise temporary or intermittent sources of power for functions having low power consumption rates, such as clocks, background processes, semi-persistent data storage, and other functions that are ancillary to audio playback. When multiple devices are used together, the combined power consumption of the devices in the system increases, and thus the cost to operate the system also increases. Accordingly, to conserve power and reduce operating costs, there is a need and a market demand for energy efficient audio playback systems.

In some examples, an audio playback device includes at least one amplifier and at least one speaker for producing audio. The audio playback device further includes power circuitry, also referred to as a local power supply, that is integrated into the device or directly connected to the device for powering the amplifier, speaker, and other components of the device, such as one or more processors and a battery. The power circuitry can include, for example, a power converter or transformer for converting AC to DC and/or for stepping the voltage up or down, a battery charger for charging the battery, and one or more power management circuits for controlling power distribution to various components of the device. Power delivery to the power circuitry can occur, for example, via a power cord providing 120 volt AC mains, or line, power; via a Universal Serial Bus (USB) cable providing power according to the USB Power Delivery (USB PD) specification; via an Ethernet cable providing power-over-Ethernet (POE); or via other types of wired (structurally conductive) connections from an external power source. Other examples of power delivery can include inductive or wireless power transfer from the external power source to the power circuitry.

It is appreciated that energy efficiency of audio playback devices is important especially in commercial or large residential applications where many (e.g., tens or hundreds) of playback devices are frequently in use, although energy conservation principles are applicable to many different environments. In such devices, the speaker can be powered from power circuitry designed to provide its greatest efficiency at the average power consumption level of the device in typical or designed-for use. For example, although a speaker may be capable of producing up to 120 watts (W), the power circuitry can be designed to operate most efficiently at approximately 75 W, which is the anticipated average power consumption level of the device.

However, while designing the power circuitry for high efficiency can reduce operating costs, such an arrangement has drawbacks. For example, the playback device may have intermittent peak power demands during certain playback situations (e.g., at high volume for certain audio tracks) that considerably exceed the capabilities of the power circuitry. For instance, the peak power demand of the device may be 120 W while the power circuitry may be designed to operate at 75 W. Accordingly, a power circuitry design suitable for average power demands may cause undesirable audio distortions or brown outs when the power demand of the amplifier exceeds the output capacity of the power circuitry. While such effects can be mitigated by limiting the power demand, this reduces the potential performance range of the speaker(s).

A possible solution for accommodating the peak power demand is to add bulk capacitors to the supply rail of the amplifier. However, the voltage across the capacitors cannot vary greatly without introducing distortion into the audio output. Since the energy stored in a capacitor increases with the voltage across the capacitor, the usable energy stored in the capacitor (e.g., the energy that can be discharged without the supply rail voltage dropping too low) is small. As a result, the capacitors would have to be very large (e.g., larger than a battery with an equivalent energy storage potential) to achieve enough capacitance so as to provide a sufficient amount of usable energy for a given application, such as powering the amplifier at peak demand. Large capacitors are undesirable because, for instance, they may exceed the volume constraints of the playback device.

The solutions described herein include one or more rechargeable batteries that supplement the output of the power circuitry of the playback device by providing an energy buffer with low internal resistance, as compared to a capacitor. During temporary peak power demands that exceed the output capacity of the power circuitry, the battery provides sufficient power to make up the difference between the output of the power circuitry and the power demand of the amplifier, thus avoiding the problems associated with audio distortions and brown outs and allowing the speakers to operate at peak performance while still utilizing power circuitry designed for greatest efficiency at power levels well below peak demand. During periods where the power demand is below peak or while the device is in an idle or partially operational state, the power circuitry can recharge the battery within the permissible power budget of the device. As a result, the playback device can achieve peak performance using power circuitry having greater efficiency than those designed for peak performance while reducing or eliminating the need for bulky and inefficient capacitors or the use of power limiting features that may degrade audio quality under certain conditions.

In some examples, the battery can provide the sole or primary source of power while the device is in a standby or idle mode. For example, the standby mode can be one in which the device does not render audio content but may perform other functions, such as monitoring a microphone input for a verbal command, operating a radio for sending and receiving data wirelessly, or otherwise performing background operations that draw a relatively small amount of power. In the standby mode, power from the power circuitry is not used to power the device as long as the battery has a sufficient charge to power the device even if the device is otherwise receiving power from the external power source. However, if the battery becomes depleted (e.g., discharged), the power circuitry recharges the battery and/or powers the device in the standby mode using an external power source (e.g., line power, POE power, etc.). In this manner, the playback device consumes little to no power from the external power source while in standby mode or is otherwise idle or unpowered. This is useful for energy conservation in general, and more specifically for devices sold or used in jurisdictions that regulate (or are proposing to regulate) the power consumption of electrical and electronic devices operating in standby and unpowered modes. In some examples, the power circuitry recharges the battery at the peak efficiency level of the power circuitry, that is, at the average power level of the device while rendering audio content (e.g., playing audio).

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

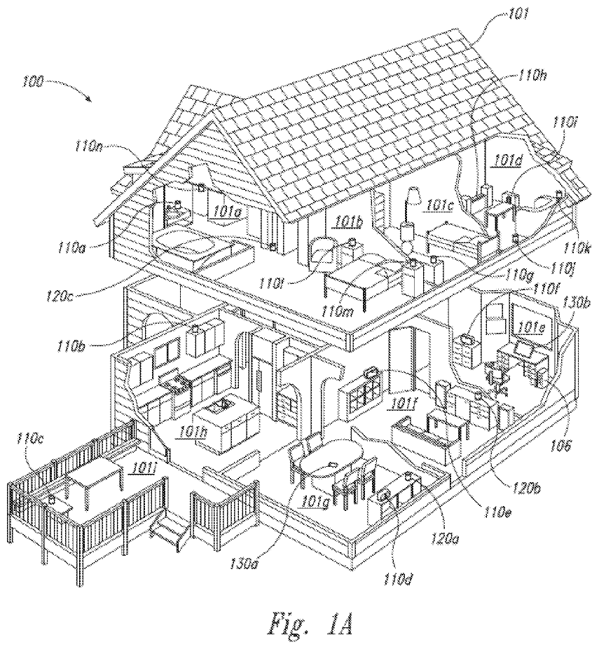

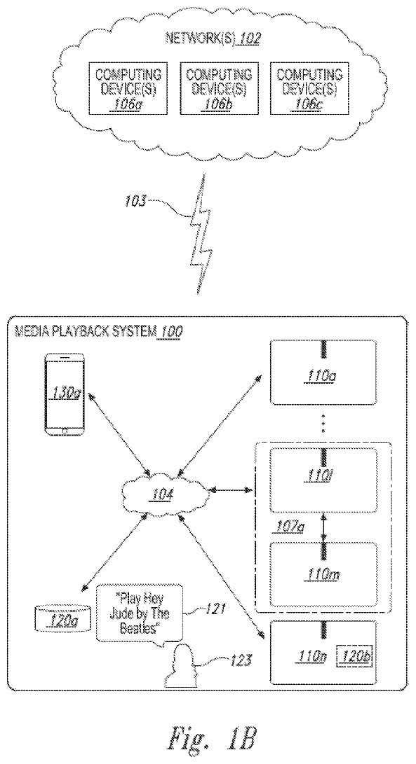

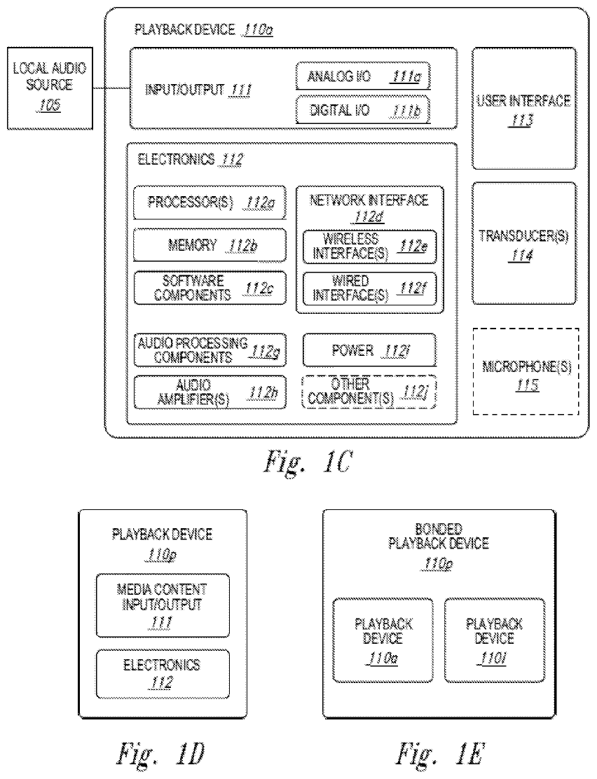

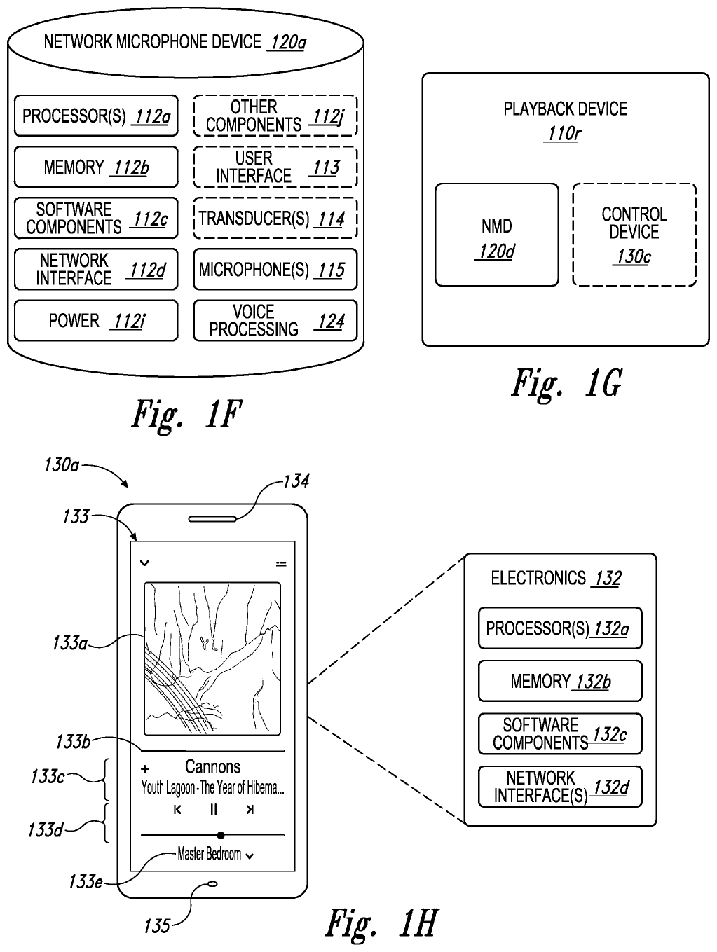

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 10le, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 1101 and 110m may be configured, for example, to play back audio content in synchrony as individual ones of playback devices 110, as a bonded play back zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media play back system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media play back system 100 in response to a request transmitted from the media play back system 100 via the links 103. In some embodiments, the cloud network 102 is further configured to receive data (e.g., voice input data) from the media playback system 100 and correspondingly transmit commands and/or media content to the media play back system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media play back system 100. The network 104 can include, for example, a wireless network (e.g., a WiFi® network, a Bluetooth®, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi®” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi® network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media play back system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 1101 and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the play back devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media play back system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi®, Bluetooth®, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for play back via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which is incorporated by reference above.

In some embodiments, the memory 112b is further configured to store data associated with the playback device 110a, such as one or more zones and/or zone groups of which the playback device 110a is a member, audio sources accessible to the play back device 110a, and/or a playback queue with which the playback device 110a (and/or another of the one or more playback devices) can be associated. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media play back system 100, so that one or more of the devices have the most recent data associated with the media play back system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi®, Bluetooth®, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114. In some embodiments, the play back device 110 may omit one or more user interface elements such as a display screen and/or a touchscreen. For instance, the playback device 110 may be implemented as a screenless play back device.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the play back device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The play back device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE ® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media play back system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media play back system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The play back control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Example Playback Device

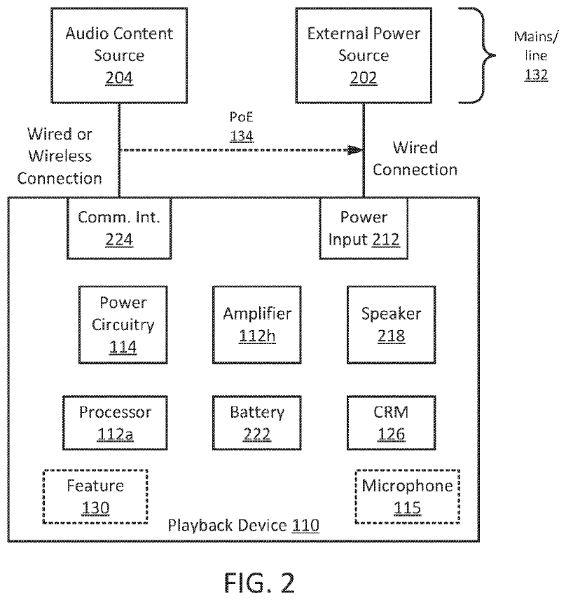

FIG. 2 is a block diagram of a playback device 110, in accordance with an example of the present disclosure. The playback device 110 includes a power input 212, power circuitry 114, an amplifier 112h, a speaker 218, at least one processor 112a, a battery 222, at least one communication interface 224, and at least one non-transitory computer-readable medium (CRM) 126. The power input 212 is configured to be connected to an external power source 202, such as a mains power source 132, a PoE power source 134, or other suitable source of power that is external to the playback device 110. One or more of the communication interface(s) 224 are configured to be operably coupled to a source of audio content 204 via a wired or wireless data connection. The audio content source 204 can be, for example, a server accessible via the Internet (e.g., a music streaming service) or another data storage device, such as a local hard drive or cloud-based data server storing digital audio data. The data connection can include, for example, one or more wired networks (e.g., Ethernet), one or more wireless networks (e.g., WiFi® or Bluetooth®), one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks). The audio content source 204 is configured to deliver media content (e.g., audio content, video content, photographs, social media content) to the playback device 110 in response to a request transmitted from the playback device 110 via the communication interface(s) 224. In some embodiments, the audio content source 204 is further configured to receive data (e.g., voice input data) from the playback device 110 and correspondingly transmit commands and/or media content to the playback device 110.

The playback device 110 may be implemented as a device configured to receive, process, and output data of a media playback system, including an audio playback system. For example, the playback device 110 can be a device that processes and renders digital audio content received from the audio content source 204, such as a smart phone or other user device, digital storage device, or other audio component (e.g., a portable media player, a receiver, a compact disc (CD) player, or a turntable) via a wired or wireless data connection. Such connections can include network-enabled connections, such as a network connection with a server-based audio content source or streaming service. In some examples, the playback device 110 includes one or more amplifiers configured to drive one or more speakers (e.g., tweeter, subwoofers, etc.) external to the playback device via a wired connection. In some examples, the playback device 110 can be implemented in any number of different environments, such as home and commercial environments (e.g., different rooms of a house, office, store, or restaurant) and mobile environments (e.g., automobiles, buses, aircraft, and vessels) having access to an external source of power, such as the power grid and generators or, in the case of mobile environments, hotel electric power/head-end power (HEP).

The playback device 110 is configured to receive media content from the audio content source 204 via the communication interface 224. For instance, the playback device 110 can stream, download, or otherwise obtain data from a network-connected resource identified using a Uniform Resource Identifier (URI), such as a Uniform Resource Locator (URL).

In operating principle, the playback device 110 is primarily powered from the external power source 202 and at least partially powered from the battery 222. The battery 222 can be a rechargeable battery capable of being recharged by the power circuitry 114 using power from the external power source 202. The power from either or both of the external power source 202 and the battery 222 can be used to power any or all of the components of the device including the power circuitry 114, the amplifier 112h, the speaker 218, the processor(s) 112a, and the communication interface(s) 224. In some examples, the battery 222 can be complemented by one or more capacitors to meet high peak-current demands. Under certain states or modes of operation, such as described in further detail below, the device 110 renders audio content received from the audio content source 204 via the amplifier(s) 112h, which drive the speaker(s) 218, primarily using power from the external power source 202 and at least partially using power from the battery 222 to supplement the power produced by the power circuitry 114. Under other states or modes of operation, the device 110 does not render any audio content via the amplifier(s) 112h and speakers(s), but rather uses power from the external power source 202, the battery 222, or both to support other operations of the device, such as monitoring for voice commands via a microphone 115, performing background processing tasks (e.g., receiving and processing software updates) using the processor(s) 112a, and charging the battery 222. For example, the microphone 115 can be configured to receive verbal commands from a user, which are processed by the processor(s) 112a and/or transmitted to a remote server for processing.

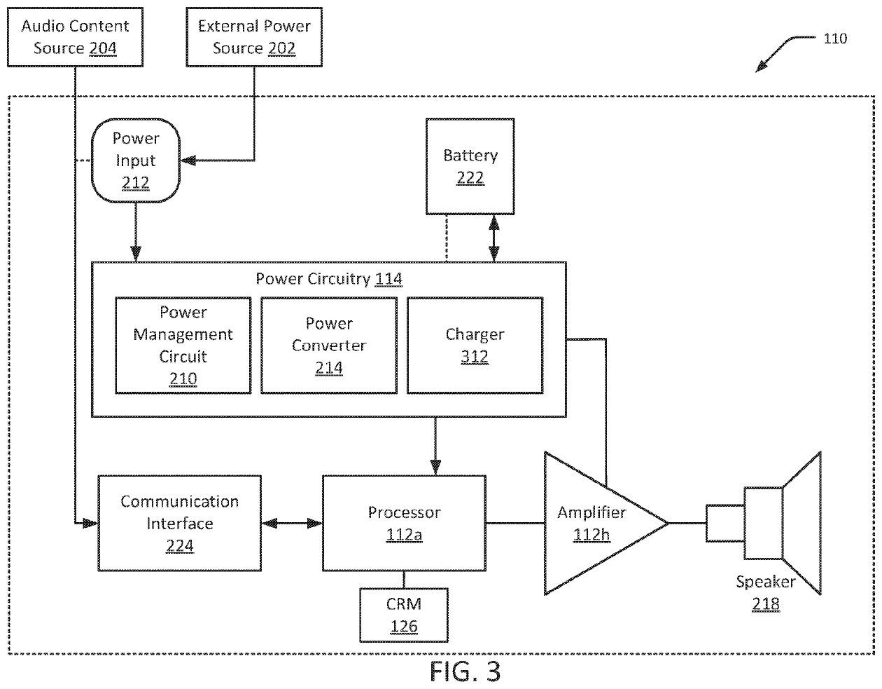

FIG. 3 is a block diagram of the playback device 110 of FIG. 2 in further detail, in accordance with an example of the present disclosure. The power input 212 is configured to receive power from the external power source 202, such as mains power, line power, power over Ethernet (POE), or any other source of general-purpose power that is external to, or not integrated with, the playback device 110. The power circuitry 114 is operably coupled to the power input 112. The power circuitry 114 is configured to receive, as an input, power from the power input 212 (e.g., mains, line, or PoE power) and/or from the battery 222 (e.g., direct current (DC) power). The power circuitry 114 is further configured to produce, as an output, power to the amplifier 112h. In an example, the power circuitry 114 includes one or more power management circuits 210, one or more battery chargers 312, and one or more power converters 214.

One or more of the communication interfaces 224 are configured to receive, as an input, audio content or other media content digitally from the audio content source 204. The communication interface(s) 224 are further configured to provide, as an output, the audio or media content digitally to the one or more processors 112a. For example, the audio content can include audio data encoded in an audio coding format, such as MP3, AAC, AC3, or any other standard, custom, or proprietary format supported by the playback device 110.

The processor(s) 112a are configured to convert the audio or media content received via the communication interface(s) 224 into an audio signal that is output to the amplifier 112h, which drives the speaker 218 to render or otherwise produce the audio content. The processor(s) 112a and the amplifier 112h are powered by the power circuitry 114. The processor(s) 112a are further configured to control the power circuitry 114 and send audio signals to the amplifier 112h, such as described in further detail below. In some examples, the processor(s) 112a include computing component(s) configured to process data and executable instructions to perform one or more operations. The operations can include, for example, causing the playback device 110 to retrieve audio data from the audio content source 204; causing the playback device 110 to send audio data to another playback device; and/or causing the playback device 110 to synchronize playback of audio content with another play back device.

The one or more non-transitory computer-readable media 126 are configured to store program instructions executable by the processor(s) 112a. The processor(s) 112a are configured to execute the instructions to control operation of the playback device 110. The playback device 110 can be operated in several states or modes of operation. For example, while in a first state of operation where the playback device 110 renders audio content received via the communication interface(s) 224 and the power input 212 is connected to the external power source 202, the processor(s) 112a are configured to (i) cause the play back device 110 to render the audio content using the amplifier 112h and the speaker 218, (ii) cause the power circuitry 114 to at least partially supply power from the power input 212 to the amplifier 112h and the processor(s) 112a, and (iii) cause the power circuitry 114 (e.g., via charger 312) to charge the battery 222 using power from the power input 112. In some examples, the non-transitory computer-readable media 126 are configured to store data associated with the playback device 110, such as data associated with the state of operation of the device 110.

The amplifier(s) 112h are configured to receive and amplify audio signals produced by the processor(s) 112a. The amplifier(s) 112h can comprise electronic devices and/or components configured to amplify the audio signals to levels sufficient for driving the speaker 218. In some examples, the amplifier(s) 112h include one or more switching or class-D power amplifiers. In other examples, the amplifier(s) 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier), or combinations of such amplifiers.

The speaker 218 can include one or more transducers or speaker drivers configured to receive the amplified audio signals from the amplifier 112h and render or otherwise produce the amplified audio signals as audible sound waves (e.g., sound waves having a frequency between about 20 Hertz (Hz) and 20 kilohertz (kHz)). In some examples, the speaker 218 can include one or more low frequency transducers (e.g., subwoofers, woofers), mid-range frequency transducers (e.g., mid-range transducers, mid-woofers), and one or more high frequency transducers (e.g., one or more tweeters). For example, “low frequency” can refer to audible frequencies below about 500 Hz, “mid-range frequency” can refer to audible frequencies between about 500 Hz and about 2 kHz, and “high frequency” can refer to audible frequencies above 2 kHz, although the speaker 218 can be configured to produce sound across different frequency ranges, such as a mid-woofer transducer configured to output sound at frequencies between about 200 Hz and about 5 kHz.

a. Operational States

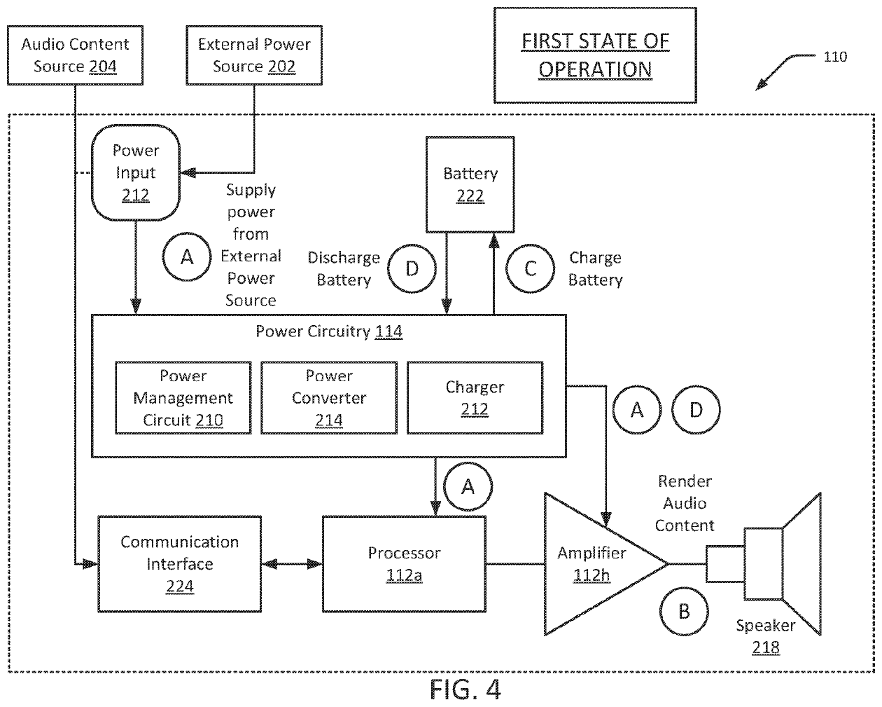

FIG. 4 is a block diagram showing the playback device 110 of FIG. 3 in the first state of operation, in accordance with an example of the present disclosure. In the first state of operation, the speaker 218 is producing audio while the playback device 110 is connected to the external power source 202 and the processor(s) 112a and the amplifier 112h are at least partially powered using power from the external power source 202, as indicated by path “A”. The processor(s) 112a can cause the speaker 218 to render audio based on the audio content received from the audio content source 204, as indicated by path “B”. During the first state of operation, the battery 222 can be charged from the external power source 202, as indicated by path “C”. In some examples, the battery 222 is charged while the power circuitry 114 is operating at or near its greatest efficiency level, that is, at or near the as-designed average power consumption level of the playback device 110.

In some examples, the battery 222 is not discharged while in the first state of operation unless and until the power demand of the amplifier 112h exceeds the maximum power output capacity of the power circuitry 114 independently of the battery 222 (e.g., during periods of peak power demand). For instance, while in the first state of operation, the processor(s) 112a can cause the power circuitry 114 to at least partially supply power from the battery 222 to the amplifier 112h while a power consumption of the amplifier exceeds a maximum power output by the power circuitry 114 independently of the battery 222, as indicated by path “D”. This causes the battery 222 to provide supplemental power to the amplifier 112h during times of peak power demand in excess of the nominal maximum power output by the power circuitry 114 while drawing power exclusively from the external power source 202.

In some examples, causing the power circuitry 114 to at least partially supply power from the power input 212 to the amplifier 112h includes causing the power circuitry 114 to couple the power input 212 to the amplifier 112h, as indicated by path “A”. In such examples, the processor(s) 112a can cause the power circuitry 114 to couple the battery 222 to the amplifier 112h to provide supplemental power to the amplifier 112h, such as when the power demand of the amplifier 112h exceeds the power output of the power circuitry 114 independently of the battery 222, as indicated by path “D”. Note that the battery 222 can be used to boost the power output of the power circuitry 114 regardless of the power output by the power circuitry 114 independently of the battery 222. For example, the battery 222 can be used to boost the power output of the power circuitry 114 while the power demand of the amplifier 112h is less than the maximum power output of the power circuitry 114. This can be helpful, for example, to control or reduce the temperature of the power circuitry 114 or to condition the output of the power circuitry 114 (e.g., to filter out power surges or brownouts).

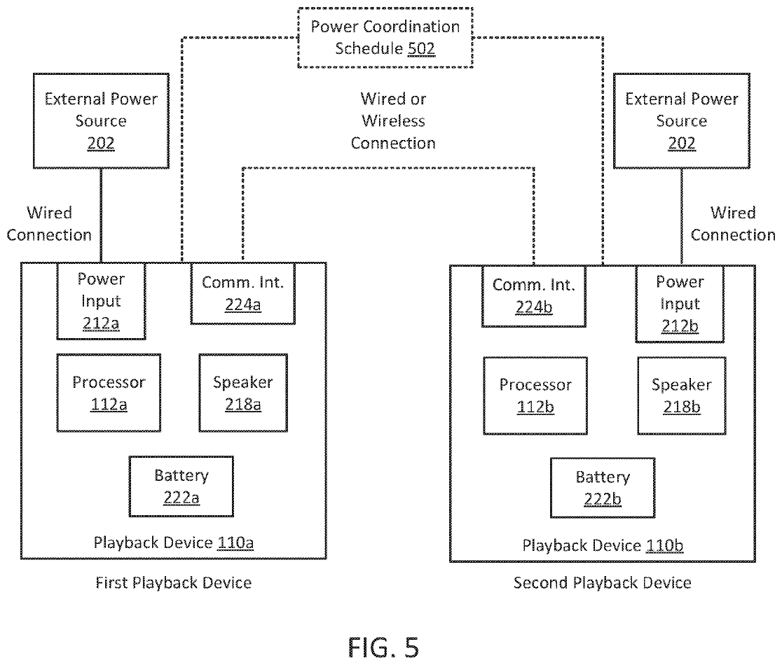

FIG. 5 is a block diagram of an audio playback system having two or more playback devices 110a, 110b, in accordance with an example of the present disclosure. In this example, while a first playback device 110a is in the first state of operation (such as described with respect to FIGS. 2 and 3), one or more processor(s) 112a of the first playback device 110a can send a command, via the at least one communication interface 224a, to at least one communication interface 224b of a second playback device 110b for causing a speaker 218b of the second playback device 110b to produce the audio synchronously with a speaker 218a of the first playback device 110a. The command can be sent over a wired or wireless data connection. Such synchronous playback is useful, for example, when two or more playback devices are in concurrent use in the same listening space so that a listener hears the same audio content from each of the devices or different channels of the same audio content in synchronization with each other. Additional details regarding audio playback synchronization among playback devices can be found, for example, in U.S. Pat. No. 8,234,395 titled, “System and method for synchronizing operations among a plurality of independently clocked digital data processing devices,” which is incorporated herein by reference in its entirety.

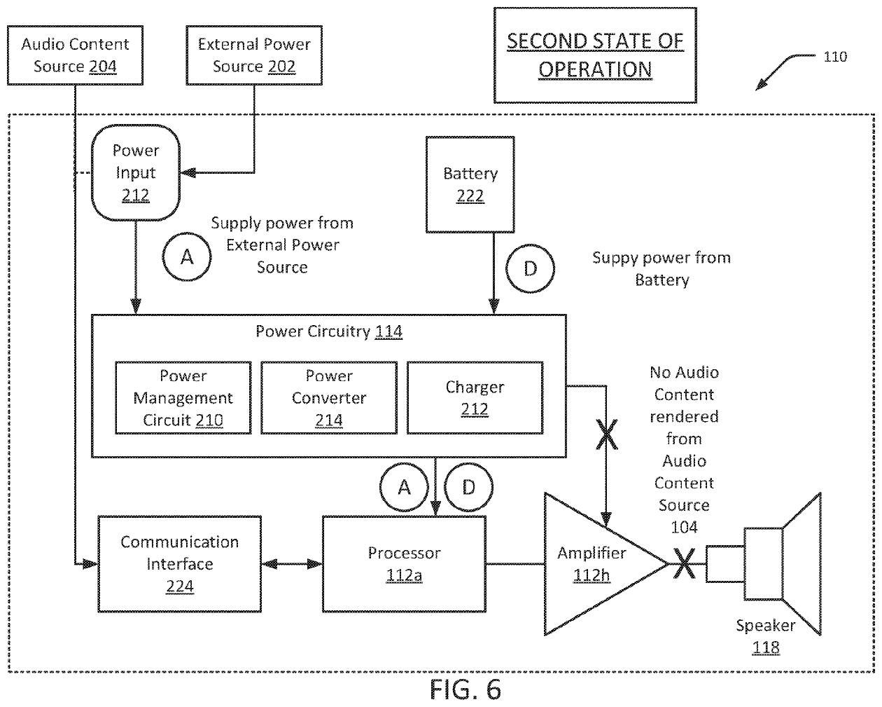

FIG. 6 is a block diagram showing the playback device 110 of FIG. 3 in the second state of operation, in accordance with an example of the present disclosure. In the second state of operation where the playback device 110 does not render audio content and the power input 212 is connected to the external power source 202, the processor(s) 112a are configured to cause the power circuitry 114 to at least partially supply power from the battery 222 to one or more of the processors 112a. In the second state of operation, the speaker 218 does not render audio from the audio content source 204, although other audio content can be played through the speaker 218, such as audible prompts, tones, or signals (e.g., a tone indicating a power or operational status of the device 110, an audible acknowledgement of a user input, an audible rendering of the time of day, an audible alarm signal, and other sounds that generally use relatively little power to drive the speaker 218). The second state of operation can include, for example, standby-type functions, where the device 110 is operating at reduced power consumption to perform a small number of operations.

In the second state of operation, the processor(s) 112a can be powered i) exclusively from the battery 222 while the power input 212 is connected to the external power source 202, as indicated by path “D”, ii) partially from the battery 222 and partially from the external power source 202, as indicated by paths “A” and “D”, or iii) exclusively from the external power source 202, as indicated by path “A”. In the second state of operation, the processor(s) 112a can, for example, perform background tasks such as waiting for and responding to a voice command via a microphone 115 (e.g., listening for a wake word or other command spoken by a user), a user input via a physical switch on the device 110 (e.g., a power switch or an input selection switch), the insertion of a data cable (e.g., a USB cable, a High-Definition Multimedia Interface (HDMI) cable, or a 3.5 mm audio cable to the device 110) or a digital command received via the communication interface(s) to begin rendering audio content or otherwise change to a different state of operation. In some examples, the processor(s) 112a can cause the power circuitry 114 to cease supplying power from the power input 212 to one or more of the processor(s) 112a and the amplifier 112h (path “A”), and cause the power circuitry 114 to begin supplying power from the battery 222 to the processor(s) and/or the amplifier 112h (path “D”).

In some examples, the playback device 110 may disallow audio playback without external power irrespective of the battery state of charge. For example, the playback device 110 can stop playback when it detects a loss-of-power event during audio playback and transition to the second state of operation or powering the play back device 100 off.

In some examples, at least a portion of the power circuitry is located in a first enclosure, and the battery and the amplifier are each located in a second enclosure that is wired to and separate from the first enclosure.

b. Battery Size

Generally, the playback device 110 consumes less power in the second state of operation than in the first state of operation, primarily due to the lack of, or significant reduction of, audio output, which significantly reduces or eliminates the power consumed by the processor(s) 112a, the amplifier 112h, and the speaker 218 as compared to when the playback device 110 is rendering the audio content from the audio content source 204. The battery 222 is sized to provide a sufficient amount of power to meet the power demands of the playback device 110 in the second state of operation. The size (e.g., the charge capacity) of the battery 222 can vary depending on the design of the playback device 110, such as discussed in further detail below. As noted above, in some examples the playback device 110 may cause the speaker 218 to produce audio while in the second state of operation, such as tones or other audible prompts and cues generated in conjunction with the performance of certain tasks (e.g., background tasks, such as responding to voice commands with tones or pre-programmed verbal responses) other than rendering the audio content received via the communication interface(s) 224.

In some examples, the size, or capacity, of the battery 222 is defined as a function of the maximum number of hours that the battery 222 can power the device 110 while in the second state of operation. For example, the battery 222 can be sized to power the device 110 in the second state of operation for up to eight hours, such as during non-business or off hours where the device 110 is not playing music or other audio. In some examples, power consumption of the device 110 in the second state of operation can be between approximately 1 W and 8 W, depending on the functions that the device 110 performs, but significantly less than the power consumption of the device 110 in the first state of operation. If, for instance, the power consumption of the device 110 is primarily used by the digital electronics (e.g., the processor(s), the radio, the CRM 126, etc.), the power consumption in the second state of operation can vary based on which digital electronics are included in the device 110. Some devices may include processors, memories, or radios that consume more power than other devices with different electronic components, or different states of operation that consume different amounts of power. For example, some devices can have a state of operation in which the device consumes approximately 3 W while a voice response feature is inactive and approximately 6-7 W while the feature is active. Accordingly, the battery size for eight hours of operation with the feature inactive may be approximately 24 watt-hours (3 W*8 hours) or 42 watt-hours (7 W*8 hours) with the feature active, plus some additional capacity for maintaining battery health. In this manner, the size of the battery is small relative to the average power consumption of the device 110 during playback of typical audio content (e.g., approximately 15-30 W) at normal or maximum volume. Furthermore, the size of the battery 222 can be relatively small to support the first state of operation because the battery 222 will discharge for short durations (e.g., one second or less) as needed for brief power demands of the amplifier 112h. In some examples, the size of the battery 222 can be, at least in part, a function of the internal impedance of the battery 222, where a lower impedance may be desired for faster discharging capability.

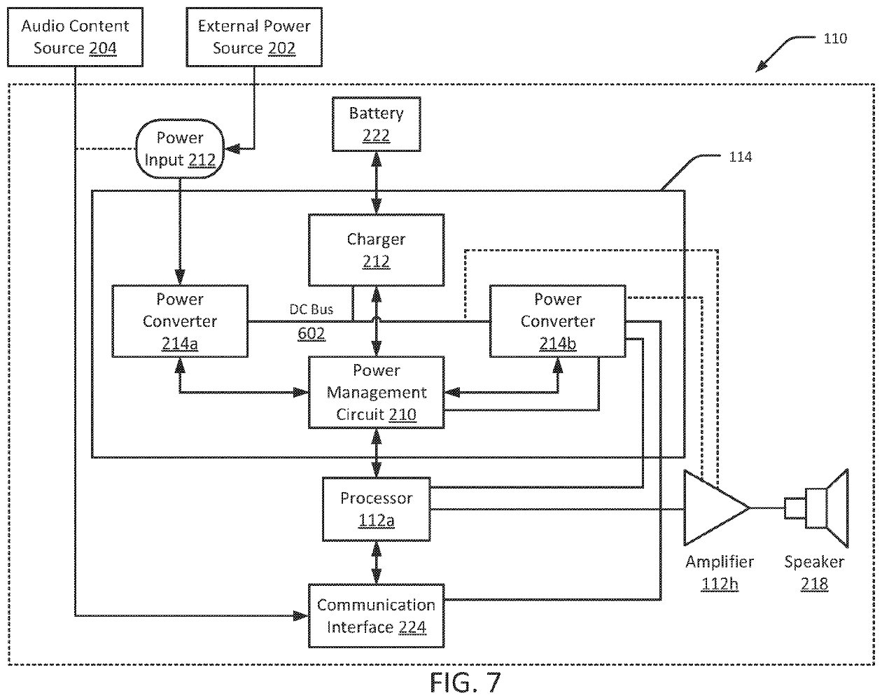

FIG. 7 is a block diagram of the playback device 110 of FIG. 2, in accordance with another example of the present disclosure. In this example, the power circuitry 114 includes two or more power converters 214a, 214b and a DC bus 602 between the power converters 214a, 214b, the charger 312, and the amplifier 112h. The use of two or more power converters allows the various components of the playback device 110 to operate at different voltage levels. For example, the power output by the first power converter 214 on the DC bus 602 can be used to power the charger 312 and the amplifier 112h, where both of these components utilize the same voltage levels. In another example, the power output by the first power converter 214a on the DC bus 602 can be used to power the charger 312 while the power output by the second power converter 214b can be used to power the amplifier 112h, where these components utilize different voltage levels.

### IV. Example Playback Device Processes

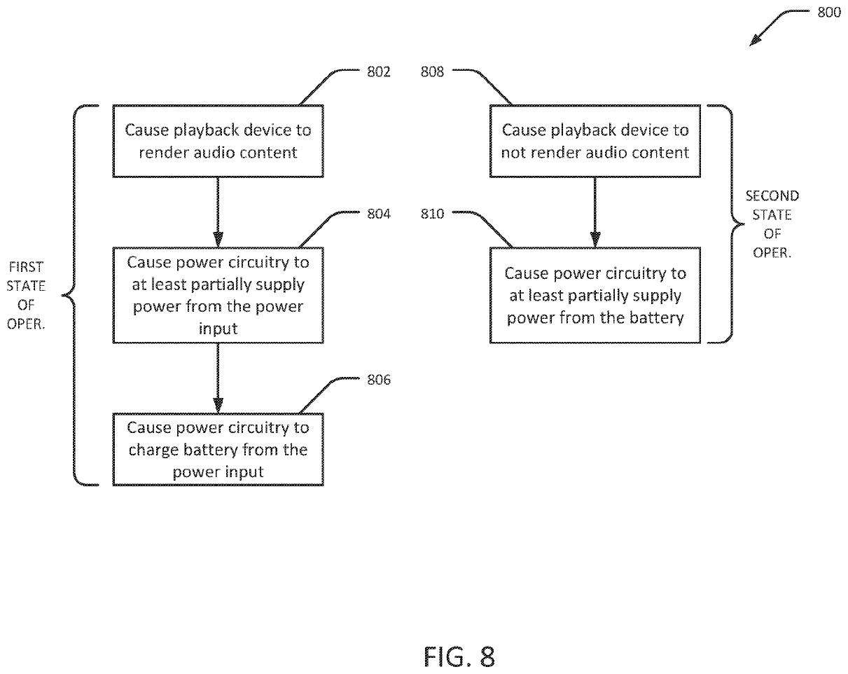

FIG. 8 is a flow diagram of a process 800 of controlling a playback device, in accordance with an example of the present disclosure. The process 800 can be implemented, for example, in the playback device 110 of FIG. 1. For example, the playback device includes a power input, an amplifier, a speaker, power circuitry, a battery, at least one processor, and at least one communication interface. The process 800 includes causing 802, while in a first state of operation where the playback device renders audio content received via the at least one communication interface and the power input is connected to an external power source, the playback device to render the audio content using the amplifier and the speaker. The process 800 further includes causing 804, while in the first state of operation, the power circuitry to at least partially supply power from the power input to the amplifier and the at least one processor. For example, the amplifier is powered at least partially from an external power source via the power input. In the first state of operation, the battery is not necessarily used to power the amplifier, but can be used to supplement the power received from the external power source, such as while the amplifier is demanding more power than the power circuitry can provide independently of the battery. The process 800 further includes causing 806, in the first state of operation, the power circuitry to charge the battery using power from the power input.

The process 800 further includes causing 808, while in a second state of operation where the playback device does not render audio content and the power input is connected to the external power source, the playback device to not render audio content. For example, the amplifier can be unpowered while in the second state of operation, or partially powered while in the second state of operation at a power level less than the peak power demand of the amplifier. The process 800 further includes causing 810, while in the second state of operation, the power circuitry to at least partially supply power from the battery to the processor, where the processor(s) are configured to control operation of the playback device. For example, while in the second state of operation, the playback device can operate in a standby mode where the device is not fully operational (e.g., not playing back audio) and where the processor is powered entirely or at least partially by the battery rather than entirely from the external power source.

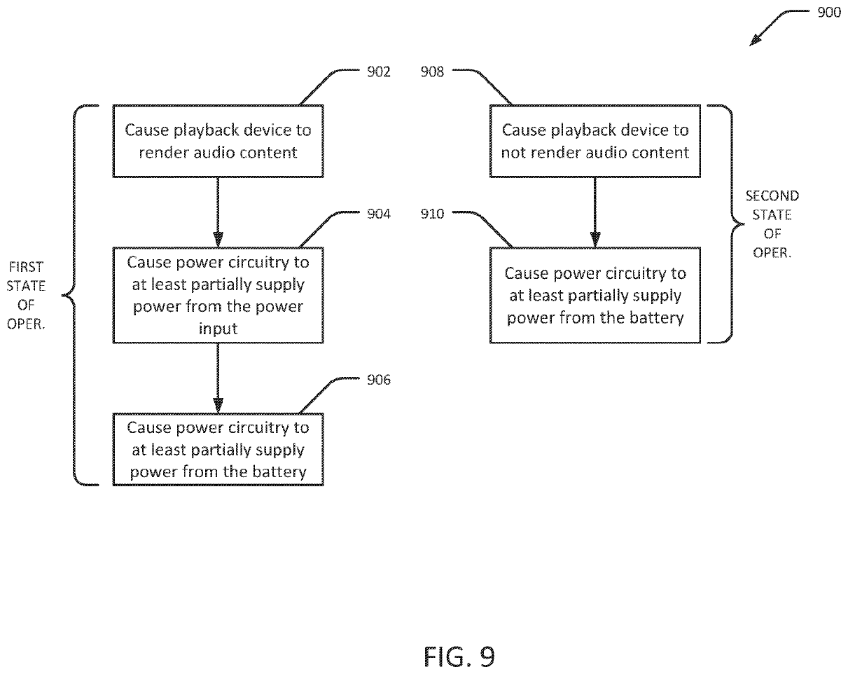

FIG. 9 is a flow diagram of a process 900 of controlling a playback device, in accordance with another example of the present disclosure. The process 900 can be implemented, for example, in the playback device 110 of FIG. 2. For example, the playback device includes a power input, an amplifier, a speaker, power circuitry, a battery, at least one processor, and at least one communication interface. The process 900 includes causing 902, while in a first state of operation where the playback device renders audio content received via the at least one communication interface and the power input is connected to an external power source, the playback device to render the audio content using the amplifier and the speaker. The process 900 further includes causing 904, while in the first state of operation, the power circuitry to at least partially supply power from the power input to the amplifier and the at least one processor. For example, the amplifier is powered at least partially from an external power source via the power input. In the first state of operation, the battery is not necessarily used to power the amplifier, but can be used to supplement the power received from the external power source, such as while the amplifier is demanding more power than the power circuitry can provide independently of the battery. For example, the amplifier can be configured to have a peak power consumption that is greater than a maximum power output capacity of the power circuitry independently of the battery. In this example, the process 900 further includes causing 906, in the first state of operation, the power circuitry to at least partially supply power from the battery to the amplifier while a power consumption of the amplifier exceeds a maximum power output capacity of the power circuitry independently of the battery. In this manner, the battery provides supplemental power to the amplifier.

The process 900 further includes causing 908, while in a second state of operation where the playback device does not render audio content and the power input is connected to the external power source, the playback device to not render audio content. For example, the amplifier can be unpowered while in the second state of operation, or partially powered while in the second state of operation at a power level less than the peak power demand of the amplifier. The process 900 further includes causing 910, while in the second state of operation, the power circuitry to at least partially supply power from the battery to the processor, where the processor(s) are configured to control operation of the playback device. For example, while in the second state of operation, the playback device can operate in a standby mode where the device is not fully operational (e.g., not playing back audio) and where the processor is powered entirely or at least partially by the battery rather than entirely from the external power source.

### V. Coordination of Standby Functions in Audio Playback Devices With Battery As Supplemental Power Source

In some examples, an audio playback device having a battery as a supplemental power source, such as described herein, can be configured to coordinate standby functions with one or more other audio playback devices. For example, if a standby task can be performed by one of two or more playback devices, the standby task can be assigned to the one playback device while the other playback device(s) remain idle or unpowered according to a power coordination schedule 502 that defines one or more standby intervals during which the devices perform standby tasks. The power coordination schedule 502 can be based, for example, on the available battery charge of each playback device, the age of each battery, the capacity of each battery, the availability of a given playback device to access external power through PoE, and/or the tasks to be performed during standby. For instance, in a room with multiple playback devices, only one playback device may be needed at a given time to monitor for a wake word or other verbal command/audible input; once the device performing the standby task receives the command, that device can signal the other devices in the room to power on, begin audio playback, and/or change operating modes. In this manner, the combined power consumption of all playback devices is reduced since only one device is performing the standby tasks while the remaining devices are idle or unpowered, according to the power coordination schedule 502.

In some examples, in a PoE implementation (e.g., external power is provided to the play back device via PoE) where the POE injector has intelligence and/or is addressable via an Internet Protocol (IP) address, one or more of the playback devices can be configured to transmit a message to the PoE injector to indicate that the device(s) no longer need power after they enter standby or are turned off. If all of the playback devices that the PoE injector is powering indicate that no power is needed, the PoE injector can stop applying a DC voltage to the ethernet cable to reduce the power losses. Upon one or more of the playback devices receiving a command, the playback devices can then send a message to the PoE injector to turn on.

In some examples, standby tasks can be allocated to one or more playback devices for execution during certain standby intervals. At the end of each standby interval, the standby tasks can be reallocated to a different playback device for a subsequent standby interval. In this manner, no single playback device executes standby tasks for an indefinite amount of time; rather, the standby tasks are rotated among multiple playback devices, thereby reducing the power consumed by a given playback device from its battery and preventing the standby tasks from terminating when the battery of one device is depleted.

For example, referring to FIG. 5, a first playback device 110a can include a first power input 212a configured to receive power from an external power source 202, a first speaker 218a, a first battery 222a, and at least one first processor 112a. A second playback device 110b can include a second power input 212b configured to receive power from the external power source 202, a second speaker 218b, a second battery 222b, and at least one second processor 112b. In this example, the first and second playback devices 110a, 110b can be similar or identical to each other; however, both devices 110a, 110b draw power primarily from the external power source 202 and have separate batteries 222a, 222b to provide supplemental power or act as stand-alone power sources for each respective device, depending on the operating state of each device.

### VI. Power Coordination

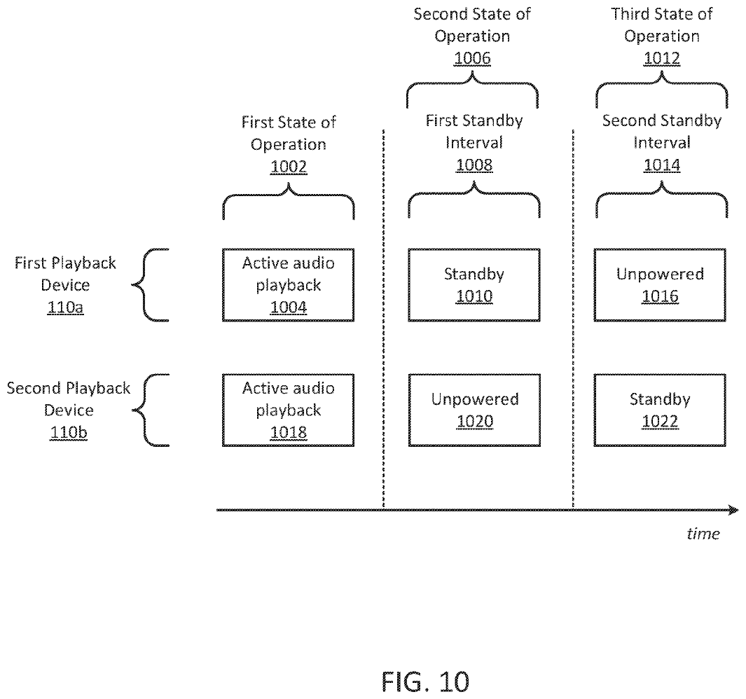

Referring to FIG. 5, the first playback device 110a and/or the second playback device 110b can generate and execute the power coordination schedule 502. The power coordination schedule 502 can be used, for instance, to determine the standby intervals and which device 110a, 110b performs the standby tasks during the standby intervals and which device 110a, 110b is unpowered during the standby intervals, such as described in further detail below with respect to FIG. 10. The power coordination schedule 502 can be generated by any of the playback devices 110a, 110b, or by another device operably coupled to the playback devices 110a, 110b via the communication interfaces 224a, 224b. The device that generates the power coordination schedule 502 is referred to as the power coordinator. The power coordinator can, in addition to generating the power coordination schedule 502, notify one or more other devices (e.g., the playback device 110a, 110b that is not acting as the power coordinator and/or other devices, such as a PoE injector) of the power coordination schedule 502 and transfer power coordination responsibility to another device.

In some examples, the power coordination schedule 502 defines the time of day (including day of week, month or year) at which the standby tasks are to begin and/or end. For example, the audio playback system may be unused during nighttime hours or other off hours. The power coordination schedule 502 can specify that the standby tasks are to be performed during these off hours. In some examples, the power coordination schedule 502 is transmitted to one or more other devices in the system so that each device in the system is aware of the schedule and can act according to the schedule. For example, if the power coordination schedule 502 defines that the first playback device 110a is scheduled to perform the standby tasks between 1:00 AM and 5:00 AM, and the second playback device 110b is scheduled to perform the standby tasks between 5:00 AM and 9:00 AM, then each playback device 110a, 110b will automatically perform the standby tasks during the hours designated by the power coordination schedule 502 without further intervention by the power coordinator.

The standby tasks can include any number of functions that can be suitably performed using low amounts of power relative to normal operation when the devices are producing audio, thus conserving energy. During standby mode, one or more components of the device, including processors, wired and/or wireless communication interfaces, microphones, indicators, and other input and output devices (e.g., switches and sensors) can be powered as needed to perform the respective standby tasks. Such standby tasks can include, for example, charging the battery 222; monitoring the microphone 115 for sounds or verbal commands (e.g., wake words to activate functions, glass breakage sounds to activate security alerts, optical or motion sensors to detect movement, or other detectable cues that are programmed to cause the device to perform certain functions); receiving and processing software updates from a server; generating and transmitting operational and/or status reports to a server (such as reports detailing device usage, battery charge level, or other activities performed by the device); displaying operational information to a user via indicators or visual displays; and powering certain components on or off as needed to perform the respective functions (such as powering up a communication interface to receive a software update and then powering the communication interface off after receiving the software update).

### VII. Example Processes for Coordination of Standby Functions in Audio Playback Devices

FIG. 10 is a block diagram showing various states of operation of the play back devices of FIG. 5, in accordance with an example of the present disclosure. Referring to FIGS. 5 and 10, in this example, the first processor 112a is configured, in a first state of operation 1002, produce sound by causing an amplifier to drive the first speaker 218a. This is also referred to as a state of active audio playback 1004, where the first device 110a is playing back audio received from, e.g., the audio content source 204. The first processor 112a is further configured, in a second state of operation 1006 and during a first standby interval 1008 (with respect to time shown on the horizontal axis of FIG. 10), to stop producing sound by causing the amplifier to cease driving the first speaker 218b. In the second state of operation 1006, the first processor 112a is at least partially powered. This is also referred to as a standby mode 1010, where the first device 110a is not playing back audio but the first processor 112a may be performing background or standby tasks using partial power from the external power source 202. The first processor 112a is further configured, in a third state of operation 1012 and during a second standby interval 1014, to disconnect power from the at least one first processor 112a. This is also referred to as an unpowered mode 1016, where the first device 110a is not playing back audio and is unpowered.

Further to this example, the second processor 112b is configured, while the first processor 112a is in the first state of operation 1002, produce sound by causing an amplifier to drive the second speaker 218b. This is also referred to as a state of active audio playback 1018, where the second device 110b is playing back audio received from, e.g., the audio content source 204 at the same time as the first device 110a is in active audio playback 1004. In some examples, the first and second devices 110a, 110b can play, during the first state of operation 1002, back audio in synchrony with each other, or the first and second devices 110a, 110b can play back different channels of the audio content or different audio content, depending on the configuration of the devices. The second processor 112b is further configured, during the first standby interval 1008, to stop producing sound by disconnecting power from the second processor 112b. This is also referred to as an unpowered mode 1020, where the second device is not playing back audio and is unpowered.

The second processor 112b is further configured, during the second standby interval 1014, to stop producing sound by causing the amplifier to cease driving the second speaker 218b and to at least partially supply power to the second processor 112b. This is also referred to as a standby mode 1022, where the second device 110b is not playing back audio but may be performing background or standby tasks using partial power from the external power source 202. In this example, the first playback device 110a can perform standby tasks during the first standby interval 1008, and the second playback device 110b can perform the standby tasks during the second standby interval 1014. In some examples, only the first device 110a or the second device 110b performs standby tasks at a given moment in time, although it may be possible for both devices to perform standby tasks at the same time under certain conditions, such as during a handover or coordination process where data and/or commands are exchanged between the playback devices 110a, 110b.

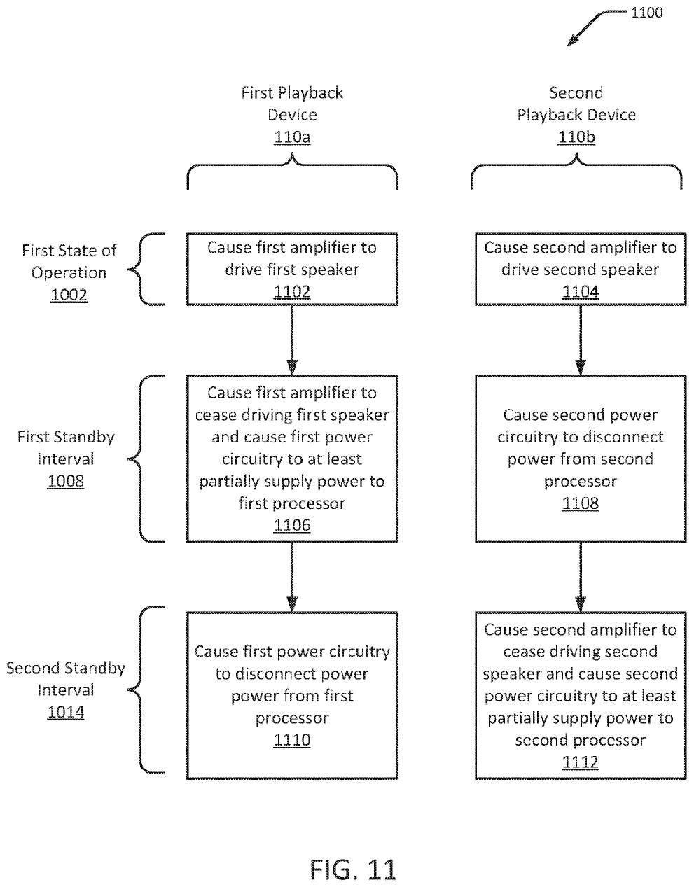

FIG. 11 is a flow diagram of an example method 1100 of coordinating standby functions in audio playback devices, in accordance with an example of the present disclosure. The method 1100 can be implemented, for example, in one or more of the playback devices 110a, 110b as shown and described with respect to FIG. 5. The method 1100 includes, in a first state of operation 1002, causing 1102 a first amplifier to drive a first speaker and causing 1104 a second amplifier to drive a second speaker. For instance, in the first state of operation 1002, the first playback device 110a and the second playback device 110b can both be actively playing back audio, either independently or in synchrony.

The method 1100 further includes, during a first standby interval 1008 of a second state of operation 1006, causing 1106 the first amplifier to cease driving the first speaker and causing the first power circuitry to at least partially supply power to the at least one first processor. The method 1100 further includes, during the first standby interval 1008 of a third state of operation 1012, causing 1108 the second power circuitry to disconnect power from the at least one second processor. For instance, in the first standby interval 1008, the first playback device 110a can perform standby tasks while the second playback device 110b can be unpowered.

The method 1100 further includes, in the third state of operation 1012 and during a second standby interval 1014, causing 1110 the first power circuitry to disconnect power from the at least one first processor. The method 1100 further includes, during the second standby interval 1014, causing 1112 the second amplifier to cease driving the second speaker and causing the second power circuitry to at least partially supply power to the second processor. For instance, in the second standby interval 1014, the first playback device 11a can be unpowered while the second playback device 110b can perform standby tasks.

### VIII. Conclusion

The above discussions relating to playback devices provide only some examples of operating environments within which functions and methods described herein may be implemented. Other operating environments and configurations not explicitly described herein may also be applicable and suitable for implementation of the functions and methods. For example, embodiments of the power circuitry as described herein can be used in any powered playback device where, in certain circumstances, the available power provided to the amplifier may be less than the peak power demand of the amplifier, resulting in audio distortion unless the available power is supplemented by the battery to achieve the total power demanded by the amplifier.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### IX. EXAMPLES

Example 1 provides a method of controlling a playback device comprising a power input configured to receive power from an external power source, an amplifier, a speaker, power circuitry, a battery, at least one processor, and at least one communication interface, the method comprising: causing, while in a first state of operation where the playback device renders audio content received via the at least one communication interface and the power input is connected to an external power source: the playback device to render the audio content using the amplifier and the speaker, the power circuitry to at least partially supply power from the power input to the amplifier and the at least one processor, and the power circuitry to charge the battery using power from the power input; and causing, while in a second state of operation where the playback device does not render audio content and the power input is connected to the external power source, the power circuitry to at least partially supply power from the battery to at least one processor configured to control operation of the playback device.

Example 2 includes the subject matter of Example 1, further comprising causing the power circuitry to cease supplying power from the power input to the at least one processor.

Example 3 includes the subject matter of Examples 1 or 2, wherein the amplifier has a peak power consumption that is greater than a maximum power output capacity of the power circuitry independently of the battery, the method further comprising causing, in the first state of operation, the power circuitry to at least partially supply power from the battery to the amplifier while a power consumption of the amplifier exceeds a maximum power output capacity of the power circuitry independently of the battery.

Example 4 includes the subject matter of any one of Examples 1-3, further comprising causing the power circuitry to supply power from the power input to the battery.

Example 5 includes the subject matter of Example 4, wherein the device comprises a charging circuit, and wherein causing the power circuitry to supply power from the power input to the battery comprises causing the charging circuit to supply power from the power input to the battery.

Example 6 includes the subject matter of Examples 4 or 5, wherein the device further comprises a converter circuit, and wherein causing the power circuitry to supply power from the power input to the battery comprises causing the converter circuit to convert power from the power input and to supply the converted power from the converter circuit to the battery via the charging circuit.

Example 7 includes the subject matter of any one of Examples 1-6, further comprising causing, in the second state of operation, the power circuitry to cease supplying power to the amplifier.

Example 8 includes the subject matter of any one of Examples 1-7, wherein the power circuitry comprises a first power converter coupled between the power input and a direct current (DC) bus and a second power converter coupled between the DC bus and the amplifier.

Example 9 includes the subject matter of any one of Examples 1-8, wherein a maximum power output by the battery is less than a maximum power output capacity of the power circuitry independently of the battery.

Example 10 includes the subject matter of Example 1, wherein a power capacity of the battery per unit time is less than a maximum power output capacity of the power circuitry independently of the battery per the unit time while in the first state of operation.

Example 11 includes the subject matter of any one of Examples 1-10, further comprising sending a command, via the at least one communication interface, to a second playback device for causing a speaker of the second playback device to produce the audio synchronously with the speaker of the first playback device.

Example 12 includes the subject matter of any one of Examples 1-11, wherein the at least one communication interface includes the power input.

Example 13 includes the subject matter of any one of Examples 1-12, wherein the at least one communication interface includes a power over Ethernet (PoE) port.

Example 14 includes the subject matter of any one of Examples 1-13, further comprising causing, in the second mode of operation, the power circuitry to at least partially supply power from the battery to an electronic feature operatively coupled to the battery.

Example 15 includes the subject matter of Example 14, wherein the electronic feature is at least one of a microphone, a radio, a storage device, or a silicon-on-chip (SoC) device.

Example 16 includes the subject matter of any one of Examples 1-15, wherein at least a portion of the power circuitry is located in a first enclosure, and wherein the battery and the amplifier are each located in a second enclosure that is wired to and separate from the first enclosure.

Example 17 includes the subject matter of any one of Examples 1-16, wherein causing the power circuitry to at least partially supply power from the power input to the amplifier includes causing the power circuitry to couple the power input to the amplifier.

Example 18 provides a playback device comprising: a power input configured to receive power from an external power source; power circuitry operably coupled to the power input; a battery operably coupled to the power circuitry; at least one communication interface; a speaker; an amplifier operably coupled to the power circuitry and configured to drive the speaker; and at least one processor operably coupled to the power circuitry and configured to cause the playback device to perform the method of any one of Examples 1-17.

Example 19 provides an audio playback system comprising: a first playback device comprising a first power input configured to receive power from an external power source; first power circuitry operably coupled to the first power input; a first speaker; a first amplifier operably coupled to the first power circuitry and configured to drive the first speaker in at least one state of operation; at least one first processor operably coupled to the first power circuitry and the first amplifier; and a second playback device comprising a second power input configured to receive power from the external power source; second power circuitry operably coupled to the second power input; a second speaker; a second amplifier operably coupled to the second power circuitry and configured to drive the second speaker in the at least one state of operation; and at least one second processor operably coupled to the second power circuitry and the second amplifier, and wherein the at least one first processor is configured to: in a first state of at least one state of operation, cause the first amplifier to drive the first speaker, in a second state of the at least one state of operation and during a first standby interval, cause the first amplifier to cease driving the first speaker and cause the first power circuitry to at least partially supply power to the at least one first processor, and in a third state of the at least one state of operation and during a second standby interval, cause the first power circuitry to disconnect power from the at least one first processor, and wherein the at least one second processor is configured to: while the at least one first processor is in the first state, cause the second amplifier to drive the second speaker, during the first standby interval, cause the second power circuitry to disconnect power from the at least one second processor, and during the second standby interval, cause the second amplifier to cease driving the second speaker and cause the second power circuitry to at least partially supply power to the second processor.

Example 20 includes the subject matter of Example 19, wherein the first playback device has a first battery operably coupled to the first power circuitry, wherein the second playback device has a second battery operably coupled to the second power circuitry, wherein the at least one first processor is configured to, during the first standby interval, cause the first power circuitry to at least partially supply power from the first battery to the at least one first processor, and wherein the at least one second processor is configured to, during the second standby interval, cause the second power circuitry to at least partially supply power from the second battery to the at least one second processor.

Example 21 includes the subject matter of Example 20, wherein the at least one first processor is configured to, during the first standby interval, cause the first power circuitry to disconnect power from the first power input to the at least one first processor, and wherein the at least one second processor is configured to, during the second standby interval, cause the second power circuitry to disconnect power from the second power input to the second processor.

Example 22 includes the subject matter of any one of Examples claims 19-21, further comprising a communication network, wherein the first playback device and the second playback device are each configured to receive audio data via the communication network, and wherein the at least one first processor and the at least one second processor are configured to cause the first and second speakers, respectively, to produce audio based on the audio data in synchrony with each other.

Example 23 includes the subject matter of Example 22, wherein the at least one first processor is configured to receive, via the communication network, the audio data from an audio content source, and to send, via the communication network, the audio data to the second playback device.

Example 24 includes the subject matter of any one of Examples 22-23, wherein the at least one first processor is configured to send, via the communication network, a command to the at least one second processor causing the at least one second processor to enter one of: a fourth state in which the at least one second processor causes the second power circuitry to disconnect power from the at least one second processor; and a fifth state in which the at least one second processor causes the second amplifier to cease driving the second speaker and causes the second power circuitry to at least partially supply power to the at least one second processor.

Example 25 includes the subject matter of any one of Examples 22-24, wherein the communication network includes a power over Ethernet (PoE) port, and wherein the system comprises a PoE injector configured to send, via the communication network, a command to the at least one first processor and/or the at least one second processor to disconnect power from the at least one first processor and/or the at least one second processor for a predetermined time.

Example 26 includes the subject matter of any one of Examples 22-25, wherein the second playback device comprises at least one third processor configured to send, via the communication network, a power coordination schedule to the at least one first processor and/or the at least one second processor, the power coordination schedule defining the first standby interval and the second standby interval.

Example 27 includes the subject matter of any one of Examples 22-26, wherein the at least one first processor is configured to send, via the communication network, a command to the at least one second processor causing the at least one second processor to enter the second state of operation or the third state of operation.

Example 28 provides an audio playback device configured for use with the system of any one of claims 19-27.

Example 29 provides a method of controlling first and second playback devices each comprising first and second power inputs, amplifiers, speakers, power circuitry, batteries, communication interfaces, and processors, the method comprising: in a first state, causing the first and second amplifiers to drive the first and second speakers, respectively; in a second state and during a first standby interval, causing the first amplifier to cease driving the first speaker, causing the second amplifier to drive the second speaker, causing the first power circuitry to at least partially supply power to the at least one first processor, and causing the second power circuitry to disconnect power from the at least one second processor; and in a third state and during a second standby interval, causing the first amplifier to drive the first speaker, causing the second amplifier to cease driving the second speaker, causing the first power circuitry to disconnect power from the at least one first processor; and causing the first power circuitry to at least partially supply power to the at least one first processor.

1-29. (canceled)

30: A method of controlling a playback device comprising a power input configured to receive power from an external power source, an amplifier, a speaker, power circuitry, a battery, at least one processor, and at least one communication interface, the method comprising:
causing, while in a first state of operation where the playback device renders audio content received via the at least one communication interface and the power input is connected to the external power source:
the playback device to render the audio content using the amplifier and the speaker,
the power circuitry to at least partially supply power from the power input to the amplifier and the at least one processor, and
the power circuitry to charge the battery using power from the power input; and
causing, while in a second state of operation where the playback device does not render the audio content and the power input is connected to the external power source, the power circuitry to at least partially supply power from the battery to the at least one processor, wherein the at least one processor is configured to control operation of the playback device.

31: The method of claim 30, wherein:
the amplifier has a peak power consumption that is greater than a maximum power output capacity of the power circuitry independent of the battery; and
the method further comprises causing, in the first state of operation, the power circuitry to at least partially supply power from the battery to the amplifier while a power consumption of the amplifier exceeds the maximum power output capacity of the power circuitry independent of the battery.

32: The method of claim 30, wherein:
the playback device comprises a charging circuit; and
causing the power circuitry to charge the battery comprises causing the charging circuit to supply power from the power input to the battery.

33: The method of claim 32, wherein:
the playback device further comprises a converter circuit; and
causing the charging circuit to supply power from the power input to the battery comprises causing the converter circuit to:
generate converted power from the power input, and
supply the converted power from the converter circuit to the battery via the charging circuit.

34: The method of claim 30, wherein the power circuitry comprises:
a first power converter coupled between the power input and a direct current bus; and
a second power converter coupled between the direct current bus and the amplifier.

35: The method of claim 30, wherein a maximum power output by the battery is less than a maximum power output capacity of the power circuitry independent of the battery.

36: The method of claim 30, wherein a power capacity of the battery per unit time is less than a maximum power output capacity of the power circuitry independent of the battery per the unit time while in the first state of operation.

37: The method of claim 30, wherein:
the playback device is a first playback device; and
the method further comprises sending a command, via the at least one communication interface, to a second playback device for causing a speaker of the second playback device to render the audio content synchronously with the speaker of the first playback device.

38: The method of claim 30, wherein the at least one communication interface includes a power over Ethernet port.

39: The method of claim 30, further comprising causing, in the second state of operation, the power circuitry to at least partially supply power from the battery to an electronic feature operatively coupled to the battery, wherein the electronic feature is at least one of a microphone, a radio, a storage device, or a silicon-on-chip device.

40: The method of claim 30, wherein:
at least a portion of the power circuitry is located in a first enclosure; and
the battery and the amplifier are each located in a second enclosure that is wired to the first enclosure.

41: A playback device comprising:
a power input configured to receive power from an external power source;
power circuitry operably coupled to the power input;
a battery operably coupled to the power circuitry;
at least one communication interface;
a speaker;
an amplifier operably coupled to the power circuitry and configured to drive the speaker; and
at least one processor operably coupled to the power circuitry and configured to cause the playback device to:
cause, while in a first state of operation where the playback device renders audio content received via the at least one communication interface:
the playback device to render the audio content using the amplifier and the speaker,
the power circuitry to at least partially supply power from the power input to the amplifier and the at least one processor, and
the power circuitry to charge the battery using power from the power input, and
cause, while in a second state of operation where the playback device does not render audio content, the power circuitry to at least partially supply power from the battery to at least one processor.

42: The playback device of claim 41, wherein:
the amplifier has a peak power consumption that is greater than a maximum power output capacity of the power circuitry independent of the battery; and
the at least one processor is further configured to cause the playback device to cause, in the first state of operation, the power circuitry to at least partially supply power from the battery to the amplifier while a power consumption of the amplifier exceeds the maximum power output capacity of the power circuitry independent of the battery.

43: The playback device of claim 41, further comprising a charging circuit, wherein causing the power circuitry to charge the battery comprises causing the charging circuit to supply power from the power input to the battery.

44: The playback device of claim 43, further comprising a converter circuit, wherein causing the charging circuit to supply power from the power input to the battery comprises causing the converter circuit to:
generate converted power from the power input; and
supply the converted power from the converter circuit to the battery via the charging circuit.

45: The playback device of claim 41, wherein:
the playback device further comprises an electronic feature operatively couped to the battery;
the electronic feature is at least one of a microphone, a radio, a storage device, or a silicon-on-chip device; and
the at least one processor is further configured to cause, in the second state of operation, the power circuitry to at least partially supply power from the battery to the electronic feature.

46: An audio playback system comprising:
a first playback device comprising:
a first power input configured to receive power from an external power source,
first power circuitry operably coupled to the first power input,
a first speaker,
a first amplifier operably coupled to the first power circuitry and configured to drive the first speaker, and
at least one first processor operably coupled to the first power circuitry and the first amplifier; and
a second playback device comprising:
a second power input configured to receive power from the external power source,
second power circuitry operably coupled to the second power input,
a second speaker,
a second amplifier operably coupled to the second power circuitry and configured to drive the second speaker, and
at least one second processor operably coupled to the second power circuitry and the second amplifier;
wherein the at least one first processor is configured to:
in a first state of operation, cause the first amplifier to drive the first speaker,
in a second state of operation and during a first standby interval, cause the first amplifier to cease driving the first speaker and cause the first power circuitry to at least partially supply power to the at least one first processor, and
in a third state of operation and during a second standby interval, cause the first power circuitry to disconnect power from the at least one first processor; and
wherein the at least one second processor is configured to:
while the at least one first processor is in the first state of operation, cause the second amplifier to drive the second speaker,
during the first standby interval, cause the second power circuitry to disconnect power from the at least one second processor, and
during the second standby interval, cause the second amplifier to cease driving the second speaker and cause the second power circuitry to at least partially supply power to the at least one second processor.

47: The system of claim 46, wherein:
the first playback device has a first battery operably coupled to the first power circuitry;
the second playback device has a second battery operably coupled to the second power circuitry;
the at least one first processor is configured to, during the first standby interval, cause the first power circuitry to at least partially supply power from the first battery to the at least one first processor; and
the at least one second processor is configured to, during the second standby interval, cause the second power circuitry to at least partially supply power from the second battery to the at least one second processor.

48: The system of claim 47, wherein:
the at least one first processor is configured to, during the first standby interval, cause the first power circuitry to disconnect the first power input from the at least one first processor; and
the at least one second processor is configured to, during the second standby interval, cause the second power circuitry to disconnect the second power input from the at least one second processor.

49: The system of claim 46, further comprising a communication network, wherein:
the first playback device and the second playback device are each configured to receive audio data via the communication network; and
the at least one first processor and the at least one second processor are configured to cause the first and second speakers, respectively, to produce audio based on the audio data in synchrony with each other.
